(19) United States
(12) Patent Application Publication
(10) Pub. No.: US 2008/0133462 A1
(43) Pub. Date: Jun. 5, 2008

(54) System for remote data geocoding

(76) Inventors: James A. Aylward, Belmont, MA (US); Douglas G. Dempster, Andover, MA (US)

Correspondence Address: Mark J. Pandiscio;Pandiscio & Pandiscio, P.C., 470 Totten Pond Road, Waltham, MA, 02451-1914, US

(21) Appl. No.: 11/821,761

(22) Filed: Jun. 25, 2007

Related U.S. Application Data
(60) Provisional application No. 60/816,158, filed on Jun. 23, 2006.

(51) Int. Cl. G06F 17/30

(52) U.S. Cl. 707/2; 707/E17.018

(57) ABSTRACT

A system for accessing geographical data residing in a plurality of disparate data sets and determining spatial relationships between geographic locations specified in the disparate data sets, the system comprising: an accessing component for accessing geographical data residing in a plurality of disparate data sets; a registration component for establishing spatial registration between the geographical data residing in the disparate data sets; and a geospatial analysis engine for determining spatial relationships between geographic locations specified in the disparate data sets.

### REFERENCE TO PENDING PRIOR PATENT APPLICATION

This patent application claims benefit of pending prior U.S. Provisional Patent Application Ser. No. 60/816,158, filed Jun. 23, 2006 by James Aylward for REMOTE DATA GEOCODING (Attorney's Docket No. HDM-7 PROV), which patent application is hereby incorporated herein by reference.

### FIELD OF THE INVENTION

This invention relates to the analysis of geographic information in general, and more particularly to (i) establishing spatial registration between the data sets of a plurality of disparate geographic information data sources, and (ii) determining spatial relationships between geographic locations specified in the disparate data sets of the plurality of geographic data sources.

### BACKGROUND OF THE INVENTION

A rich variety of data exists regarding geographic information. Examples of this geographic information include property locations, outlines of real estate parcels, locations of hazard areas, etc.

Users of this geographic information often wish to understand the spatial relationships between geographic locations specified in the geographic data sets, in order to provide analyses regarding those geographic locations specified in the data sets.

As used herein, the term geographic location is intended to mean substantially any geographic element and/or feature and/or object, e.g., a geographic location may be a point, a parcel of land, a building, a road, a river, a geographic region (e.g., a geopolitical region such as a county, or a topographical region such as a valley, or a demarcated region such as a temporary flood zone), etc.

In some cases, the geographic locations are specified in a single, unified data set. In other cases, the geographic locations are specified in disparate geographic data sets.

By way of example but not limitation, one might wish to know whether a geographical location (e.g., a particular building) is located within another geographical region (e.g., an area that is susceptible to earthquakes). Where the first geographical location of the building and the second geographical location of the boundaries of the earthquake-susceptible area are stored in a single, unified data set, standard Geographic Information System (GIS) tools may be used to make the necessary determination. However, where the location of the building is stored in a first data set, and where the boundaries of the earthquake-susceptible area are stored in a second, disparate data set, it is more difficult to determine the spatial relationship between the geographic locations specified in the two disparate data sets.

Where the geographic locations are specified in two disparate data sets, the “standard” approach for determining the spatial relationships between the geographic locations is to first incorporate the plurality of disparate data sets into a single, unified data set. If desired, this single unified data set can be created as a separate step preliminary to accessing the data set with an application program; or alternatively, this single unified data set can be created at the time that it is loaded into an application program. This single, unified data set is then utilized by a Geographic Information System (GIS) to make spatial relationship calculations such as “distance to”, or “is inside of”, or “intersects with”, etc. A variety of software products currently exist for performing these sorts of spatial relationship calculations using single, unified data sets, and a large number of databases are currently available from government and private sources which can be downloaded into, or delivered via DVD or other “hard” media, or otherwise installed, in a unified manner on the GIS system.

However, there are several serious deficiencies to this “standard” approach for determining spatial relationships between geographic locations specified in a plurality of disparate data sets.

First, there are many data sources which only permit access to their geographic data sets via specific queries submitted through the Web. Thus, these data sources prohibit “wholesale” downloading of their geographic data sets and instead only provide the geographic data in response to specific queries received through the Web. Thus, it is difficult to incorporate the geographic data from these Web sites into a single, unified data set.

Second, the geographic data present in many data sources may not be in a format which is conducive to performing a desired geographic analysis and, in any case, the geographic data present in the disparate databases may not be in a unified data format. Thus, where the geographic data is extracted from several disparate data sources, spatial registration must first be established between the disparate data sets so that the data may be used in a coordinated fashion.

Third, this “standard” approach presumes that the user has GIS tools available, and also has the skill to use them. However, this is frequently not the case.

In addition to the foregoing, of particular interest are a large set of Web-based services which can provide geographically-registered images of geographic information. In other words, these Web-based services provide images of geographic information which include known geographic reference points, such that the images can be placed into geographic registration with other geographic data. One example of such a service is currently available at:

http://wetlandswms.er.usgs.gov/service_info.html

See, for example, FIG. 1, which shows an exemplary page from the above-identified Web site. Geographic data (in this case wetlands area information) is available via the aforementioned Web site, but the Web site provides only a limited set of tools for utilizing this data. By way of example but not limitation, the aforementioned Web site does not provide any way for a user to query whether a specific geographic location is located within a wetlands area.

Furthermore, there is currently no convenient way to take the geographically-registered images of the aforementioned Web site and use them in a coordinated fashion with additional data held in another, disparate data set, e.g., which uses a different data format. By way of example but not limitation, there is currently no convenient way to take the geographically-registered images of the aforementioned Web site and use them in combination with another data set (e.g., a portfolio of insured properties specified in longitude/latitude coordinates) so as to determine spatial relationships between the geographic locations specified by the two disparate data sets (e.g., to determine whether a portfolio of insured properties has any structures located within a wetlands area).

What is needed, then, is a system which allows users to:
(i) specify two or more data sets (and their access addresses) that the user wishes to utilize—these data sets could be either Web-based or local data sets; and
(ii) specify the spatial relationship (e.g., “distance to”, or “is inside of”, or “intersects with” etc.) which the user wishes to determine between the geographic locations specified by the disparate data sets.

From this information, the system should then:
(iii) determine the appropriate approach for accessing the data sets identified by the user;
(iv) generate the appropriate data requests to retrieve the desired geographic data;
(v) establish the appropriate spatial registration between the disparate data sets;
(vi) determine the requested spatial relationship between the geographic locations specified by the disparate data sets; and
(vii) return the results to the user.

A system capable of providing the aforementioned features would constitute a significant improvement in the art.

### SUMMARY OF THE INVENTION

In view of the foregoing, the present invention is directed to a novel system for (i) accessing geographical data residing in a plurality of disparate data sets, (ii) establishing spatial registration between the geographic data residing in the disparate data sets, and (iii) determining spatial relationships between geographic locations specified in the disparate data sets, where any or all of the data sets are remote from the user.

The novel system generally comprises an input/output module, a plurality of data loaders and a geospatial analysis engine. The input/output module receives from the user (i) a list of the data sources which are to provide the geographic data, and (ii) the spatial relationships which are to be determined for geographic locations specified by the disparate data sets. A data loader is provided for each type of data source which is to be accessed, with that data loader being configured so as to determine the proper protocol for accessing the geographic data stored at the data source which that data loader is designed to access. The process of data loading is preferably automated, with the type of data loader being appropriate for the source of the data. The data loader passes the acquired geographic data to the geospatial analysis engine, along with the necessary spatial registration information so that the geographic data from disparate data sources can be used collectively. The geospatial analysis engine then determines spatial relationships between geographic locations specified by the disparate data sets. These results are passed to the input/output module, which then returns them to the user.

In accordance with the present invention, the data sources specified by the user (and accessed by the system) may include any combination of specific geographic information (i.e., a pair of latitude/longitude coordinates, or a specified pixel location on a geographically-registered image), references to local geographic information (i.e., a filename for a file stored locally for access by the GIS), or the Web URL of a remote data source.

In accordance with another feature of the present invention, the data loaders may interrogate a specified Web site to determine what data types can be obtained from that Web site and, from that list of available data types, determine what sort of request should be submitted to that Web site in order to facilitate the determination of the desired spatial relationship. By way of example but not limitation, a given Web site may be capable of providing geographic data in both image form (images) or geometric form (geometry), but one particular data format may be preferable for a specified geographic calculation requested by user. By way of example but not limitation, distance calculations may be facilitated by working in Cartesian coordinates, so it may be desirable to receive the geographic data in geometric format.

In accordance with yet another feature of the present invention, a Web-based data source may be capable of generating geographically-registered images where certain pixels of these images are set to known values, thereby designating specific geographic locations. Images in this format can be advantageously used to perform well-known Boolean algebra operations on a per-pixel basis so as to determine spatial relationships with geographical data contained in other images. Alternatively, this image data can also be used to perform calculations in a Cartesian space aligned with the 2D image.

In accordance with yet another feature of the present invention, the system may be implemented as a remote Web service, thereby allowing users to perform geographic information processing without the expense, complexity and knowledge required to install, use and maintain GIS software.

In one preferred form of the present invention, there is provided a system for accessing geographical data residing in a plurality of disparate data sets and determining spatial relationships between geographic locations specified in the disparate data sets, the system comprising:

an accessing component for accessing geographical data residing in a plurality of disparate data sets;

a registration component for establishing spatial registration between the geographical data residing in the disparate data sets; and

a geospatial analysis engine for determining spatial relationships between geographic locations specified in the disparate data sets.

In another preferred form of the present invention, there is provided a method for accessing geographical data residing in a plurality of disparate data sets and determining spatial relationships between geographic locations specified in the disparate data sets, the method comprising:

accessing geographical data residing in a plurality of disparate data sets;

establishing spatial registration between the geographical data residing in the disparate data sets; and

determining spatial relationships between geographic locations specified in the disparate data sets.

In another preferred form of the present invention, there is provided a system for accessing geographical data residing in a plurality of disparate data sets and determining spatial relationships between geographic locations specified in the disparate data sets, the system comprising:

an input component for permitting a user to specify:
(i) a plurality of disparate geographic data sources each containing a geographic data set, and the access addresses for those geographic data sources; and
(ii) a spatial relationship to be determined between geographic locations specified in the geographic data sets;

a data loader component for:
(i) determining the appropriate approach for accessing the data sets identified by the user; and
(ii) generating the appropriate data requests needed to retrieve the desired geographic data;

a geospatial analysis engine for determining the desired spatial relationships between geographic locations specified in the disparate data sets; and

an output component for returning the results of the geospatial analysis engine to the user.

In another preferred form of the present invention, there is provided a method for accessing geographical data residing in a plurality of disparate data sets and determining spatial relationships between geographic locations specified in the disparate data sets, the method comprising:

permitting a user to specify a plurality of disparate geographic data sources each containing a geographic data set, and the access addresses for those geographic data sources;

permitting a user to specify a spatial relationship to be determined between geographic locations specified in the geographic data sets;

determining the appropriate approach for accessing the data sets identified by the user;

generating the appropriate data requests needed to retrieve the desired geographic data;

determining the desired spatial relationships between geographic locations specified in the disparate data sets; and

returning the results of the geospatial analysis engine to the user.

These and other features and advantages of the present invention will be more fully disclosed or rendered obvious from the following detailed description of the preferred embodiments of the present invention.

### BRIEF DESCRIPTION OF THE DRAWINGS

The foregoing summary of the present invention, as well as the following detailed description of the preferred embodiments of the invention, is better understood when read in conjunction with the appended drawings. For the purpose of illustrating the present invention, there are shown in the drawings various exemplary constructions of the invention; however, it should be appreciated that the present invention is not limited to the specific systems disclosed.

In the drawings:

FIG. 1 is an exemplary Web page showing a Web-based service which can provide geographically-registered images of geographic information, with this particular Web page being accessible at

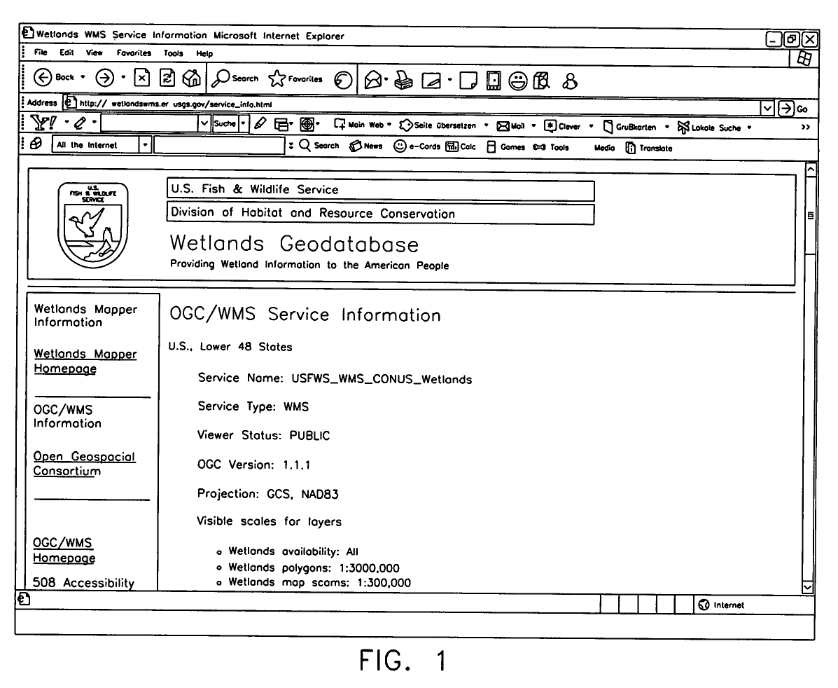

http://wetlandswms.er.usgs.gov/service_info.html;

FIG. 2 is a schematic block diagram illustrating the general architecture of a system formed in accordance with the present invention;

FIG. 3 shows how the system may access geographic data from remote Web sites;

FIG. 4 illustrates an exemplary input request and an exemplary output result which may generated in the Web site shown in FIG. 3; and

FIG. 5 illustrates an image-based technique for determining the spatial relationship between a geographic location and an image containing a geographic data set of interest.

### DETAILED DESCRIPTION OF THE PREFERRED EMBODIMENTS

The present invention is directed to a system for (i) accessing geographical data residing in a plurality of disparate sets, (ii) establishing spatial registration between the geographic data residing in the disparate sets, and (iii) determining spatial relationships between geographic locations specified in the disparate data sets, where any or all of those datasets are remote from the user.

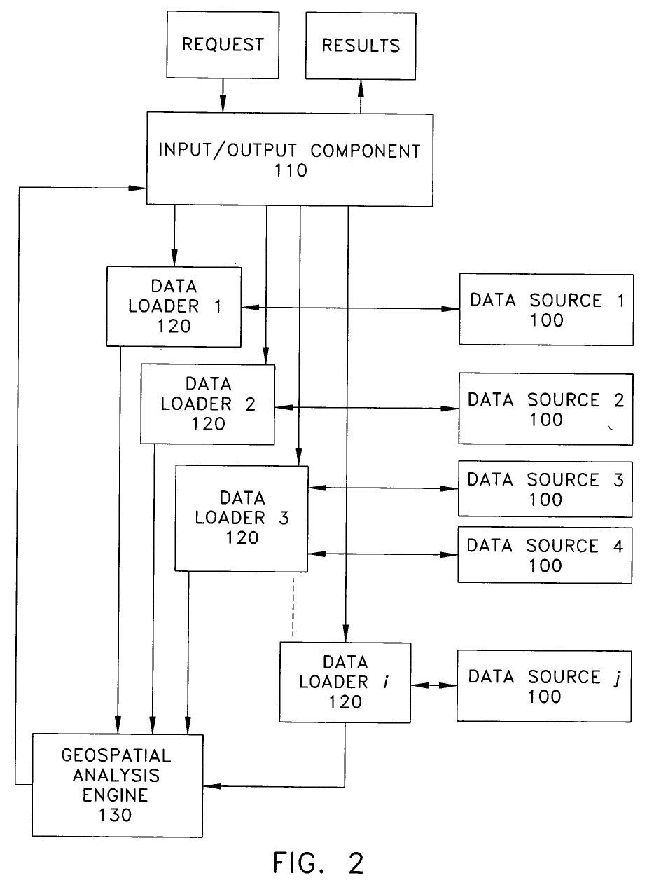

Referring now to FIG. 2, there is shown a novel system formed in accordance with the present invention. The access addresses for the data sources 100 specified by the user (e.g., URL addresses) are received by the input/output component 110. The access address for each user-specified data source 100 is passed to a data loader component 120. Each data loader component 120 determines what data formats can be provided by its associated data source 100 and then determines the format or formats which are best suited for performing the desired spatial analysis. The data loader component 120 then performs the operation needed to gather the geographical data from its associated data source 100. A unique data loader component 120 is provided for each Web site or, where multiple Web sites share a common format, for each format type (e.g. WMS service, Google Image Tile service, etc.). After the necessary data is collected by the data loader components 120, it is passed on to the geospatial analysis engine 130 along with the desired spatial relationship which is to be determined. The geospatial analysis engine 130 then performs operations on the geographical data using vector and/or raster geometry mathematics, as appropriate. By way of example but not limitation, the geospatial analysis engine 130 might perform operations on the geographical data in order to determine if two geographic lines intersect, or to determine the distance from a point to a line, etc. This functionality could be provided by any one of a number of commercially-available software products such as the ArcGIS product from ESRI (http://www.esri.com/products.html), or by the functionality provided by software toolkits such as the Geotools toolkit (http://jeotools.codehaus.org/). The geospatial analysis engine 130 computes the desired results and passes these results to the input/output component 110, which then returns the result to the user.

Those skilled in the art will recognize that the present invention may be implemented by a software module linked into a client application, or by a stand-alone software product, or by a Web-based software program, or by other methodologies.

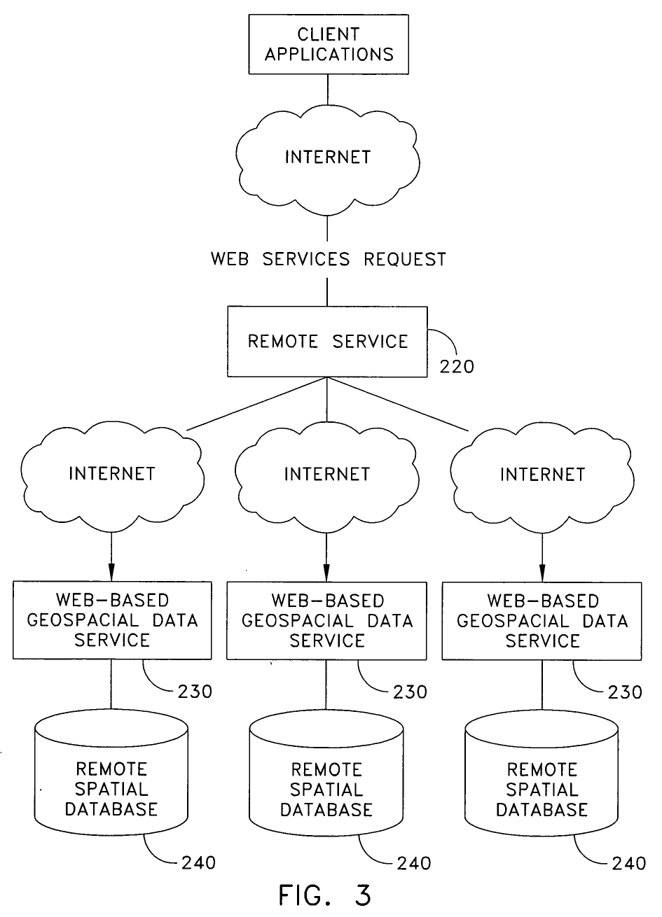

FIG. 3 further illustrates how the invention may be implemented as a remote service. In this configuration, user-specified data (e.g., data source addresses, spatial relationship parameters) is passed from a client application 210 to the novel remote service 220 (which implements the present invention) via an XML, SOAP, REST or other well known technique for communicating with software via the Web. Internal to the remote service 220 are all the functions of the system shown in FIG. 2. The novel remote service 220 then communicates with the external Web-based geospatial data services 230 to request and obtain the desired geographic information. Each Web-based geospatial data service 230 then accesses its own remote spatial database 240 to provide the requested data. Once the desired spatial relationships have been determined, the novel remote service 220 reports the results back to the client application 210 via the Web in a format appropriate to the service type.

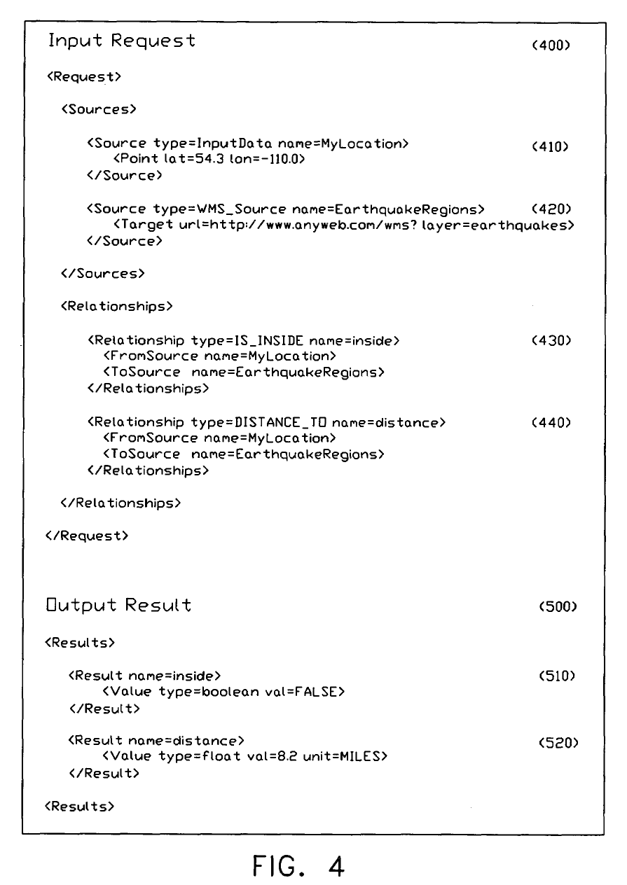

FIG. 4 provides an example of the data interface between the user and novel remote service 220.

In this example, a request 400 is submitted to the novel remote service 220. Two data sources are supplied by the user: geographic location 410, and the access address of a Web service providing earthquake region information 420. The request also specifies the desired spatial relationships that the user wishes to know: (i) whether the input location is within the boundaries of the earthquake area (which is defined by the user at 420) and, if not, (ii) the distance of the user-specified geographic location from the area 430.

FIG. 4 also illustrates the resulting data 500 for this request 400, indicating that the point of interest is not within the area (see 510), but is in fact 8.2 miles away (see 520).

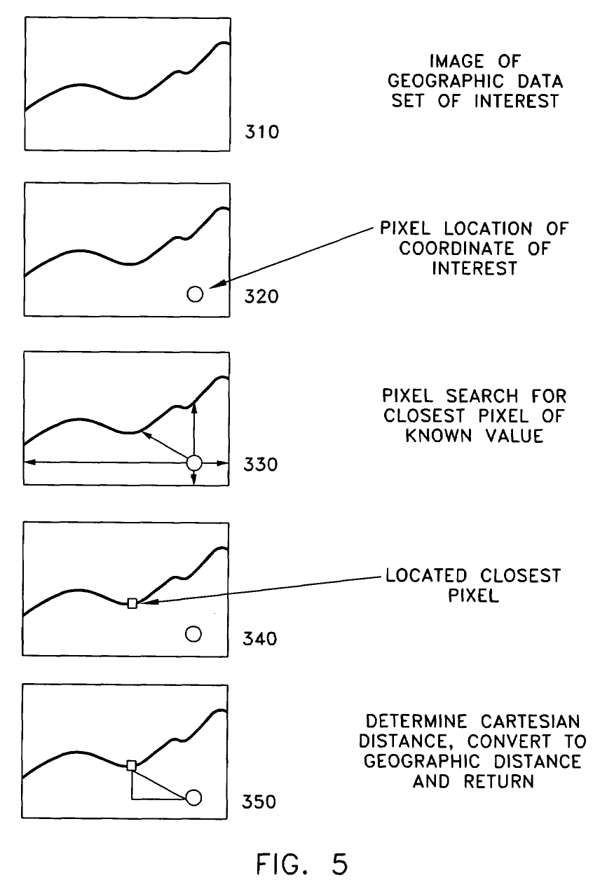

FIG. 5 illustrates one exemplary technique for determining the spatial relationship between a geographic location specified in latitude/longitude coordinates and a geographically-registered image of geographical data of interest. As noted above, the term “geographically-registered image” is intended to mean an image which includes known geographic reference points so as to permit the images to be placed into geographic registration with other geographic data. Several Web services, e.g., the Web Mapping Service (WMS), exist for providing images of geographic data sets, where the images are geographically referenced, i.e., metadata is available for the image that includes the latitude and longitude for at least 2 points on the map, and the scale of the map. From this, users of the image can translate from pixel space to geographic space (and vice versa), and can translate from distances in the Cartesian plane of the image to geographic distances (and vice versa).

In addition, these services have the ability to request that geographic information be “drawn into” (or “drawn on”) the image, using a known color or transparency value, such that only those pixels with that value are part of the geographic information in question, and any other values can be considered as “background”.

To take advantage of these two capabilities, the system first requests an image from the Web service for the geographic region surrounding a location in question, with the image being generated such that data pixels are of a known value 310. The location of interest can be placed at a pixel location within this image 320. Using the image as a Cartesian plane, the system can perform a search of pixels in the area surrounding the location of interest (see 330) so as to determine the closest pixel (see 340), if any, to the known value. From this, a Cartesian pixel-to-pixel distance can be determined and then translated to geographic distance by using the geographic registration information of the image (see 350).

### Modifications Of The Preferred Embodiments

It should be understood that many additional changes in the details, operation, steps and arrangements of elements, which have been herein described and illustrated in order to explain the nature of the present invention, may be made by those skilled in the art while still remaining within the principles and scope of the invention.

What is claimed is:

1. A system for accessing geographical data residing in a plurality of disparate data sets and determining spatial relationships between geographic locations specified in the disparate data sets, the system comprising:
an accessing component for accessing geographical data residing in a plurality of disparate data sets;
a registration component for establishing spatial registration between the geographical data residing in the disparate data sets; and
a geospatial analysis engine for determining spatial relationships between geographic locations specified in the disparate data sets.

2. A method for accessing geographical data residing in a plurality of disparate data sets and determining spatial relationships between geographic locations specified in the disparate data sets, the method comprising:
accessing geographical data residing in a plurality of disparate data sets;
establishing spatial registration between the geographical data residing in the disparate data sets; and
determining spatial relationships between geographic locations specified in the disparate data sets.

3. A system for accessing geographical data residing in a plurality of disparate data sets and determining spatial relationships between geographic locations specified in the disparate data sets, the system comprising:
an input component for permitting a user to specify:
(i) a plurality of disparate geographic data sources each containing a geographic data set, and the access addresses for those geographic data sources; and
(ii) a spatial relationship to be determined between geographic locations specified in the geographic data sets;
a data loader component for:
(i) determining the appropriate approach for accessing the data sets identified by the user; and
(ii) generating the appropriate data requests needed to retrieve the desired geographic data;
a geospatial analysis engine for determining the desired spatial relationships between geographic locations specified in the disparate data sets; and
an output component for returning the results of the geospatial analysis engine to the user.

4. A system according to claim 3 wherein the system is implemented as a Web application.

5. A system according to claim 3 wherein at least one of the disparate geographic data sources is remote from the system, and further wherein the data loader accesses the data source via a Web interface.

6. A system according to claim 3 wherein at least one of the disparate geographic data sources comprises a Web Mapping Service (WMS).

7. A system according to claim 3 wherein at least one of the disparate geographic data sources is a Web Feature Service (WFS).

8. A system according to claim 3 wherein at least one of the disparate geographic data sources is a Google Maps tile service.

9. A system according to claim 3 wherein the input component communicates with the data loader remotely via a Web interface.

10. A system according to claim 3 wherein the geospatial analysis engine communicates with the output component remotely via a Web interface.

11. A system according to claim 3 wherein at least one of the geographic data sets comprises geographically-registered images.

12. A system according to claim 3 wherein at least one of the geographic data sets comprises geographic data expressed in a geometric format.

13. A system according to claim 12 wherein the geometric format comprises Cartesian coordinates.

14. A system according to claim 3 wherein the spatial relationship comprises one from the group consisting of: “distance to”, “is inside of”, and “intersects with”.

15. A method for accessing geographical data residing in a plurality of disparate data sets and determining spatial relationships between geographic locations specified in the disparate data sets, the method comprising:
permitting a user to specify a plurality of disparate geographic data sources each containing a geographic data set, and the access addresses for those geographic data sources;
permitting a user to specify a spatial relationship to be determined between geographic locations specified in the geographic data sets;
determining the appropriate approach for accessing the data sets identified by the user;
generating the appropriate data requests needed to retrieve the desired geographic data;
determining the desired spatial relationships between geographic locations specified in the disparate data sets; and
returning the results of the geospatial analysis engine to the user.

16. A method according to claim 15 wherein the method is implemented as a Web application.

17. A method according to claim 15 wherein at least one of the disparate geographic data sources is remote from the system, and further wherein the data source is accessed via a Web interface.

18. A method according to claim 15 wherein at least one of the disparate geographic data sources comprises a Web Mapping Service (WMS).

19. A method according to claim 15 wherein at least one of the disparate geographic data sources is a Web Feature Service (WFS).

20. A method according to claim 15 wherein at least one of the disparate geographic data sources is a Google Maps tile service.

21. A method according to claim 15 wherein at least one of the geographic data sets comprises geographically-registered images.

22. A method according to claim 15 wherein at least one of the geographic data sets comprises geographic data expressed in a geometric format.

23. A method according to claim 15 wherein the geometric format comprises Cartesian coordinates.

24. A method according to claim 15 wherein the spatial relationship comprises one from the group consisting of: “distance to”, “is inside of”, and “intersects with”.

25. A system according to claim 3 wherein the user communicates with the input component remotely via a Web interface.

26. A system according to claim 3 wherein the output component communicates with the user remotely via a Web interface.
